(19) United States
(12) Patent Application Publication
(10) Pub. No.: US 2003/0087454 A1
(43) Pub. Date: May 8, 2003

(54) Method and device for chemical analysis

(76) Inventors: Gary A. Schultz, Ithaca, NY (US); Thomas N. Corso, Lansing, NY (US); Gary S. Sheldon, Aurora, NY (US); David R. Jung, Ithaca, NY (US); Christopher G. Alpha, Ithaca, NY (US); Geoffrey S. Rule, Aurora, NY (US); Xian Huang, Ithaca, NY (US); Simon J. Prosser, Ithaca, NY (US)

Correspondence Address: Michael L. Goldman, NIXON PEABODY LLP, Clinton Square, P.O. Box 31051, Rochester, NY, 14603-1051, US

(21) Appl. No.: 10/282,279

(22) Filed: Oct. 28, 2002

Related U.S. Application Data
(60) Provisional application No. 60/336,950, filed on Oct. 26, 2001.

(51) Int. Cl. G01N 30/02; G01N 1/00; B01L 3/00

(52) U.S. Cl. 436/161; 436/174; 436/178; 436/180; 422/102

(57) ABSTRACT

A disposable tube includes an inlet end and an outlet end, wherein the inlet end of a first tube is self-locking, self-aligning, self-mating, self-sealing and adapted to detachably engage an outlet end of a second tube. The tube may be filled with separation material. The tubes may be used for micro fluidic separation and fluid transfer. Also included is a tube array having a plurality of tube holders adjacent to one another. Each tube holder has a passageway configured to receive a tube. Each passageway constrains the movement of a tube in the array: allowing free movement of the tube along the tube axis, while allowing limited sideways movement of the tube, so that the tube is held in alignment with a corresponding input port of, for example, a sample transfer device. The tubes are compatible with automated sample handling systems including an array of tubes pre-filled or partially pre-filled with sample; a sample transfer device; and a robotic fluid control system for loading the tubes and actuating the sample transfer device; wherein the samples are dispensed from the tube array into a sample detection device.

This application claims the benefit of U.S. Provisional Patent Application Serial No. 60/336,950, filed Oct. 26, 2001, which is herein incorporated by reference in its entirety.

### FIELD OF THE INVENTION

The present invention relates to a method and device for chemical analysis. In particular, the present invention relates to a tube which may be used as a single tube or in parallel as a sample array. Tubes may contain separation media and may be stacked to provide multi-dimensional separations.

### BACKGROUND OF THE INVENTION

New trends in drug discovery and development are creating new demands on analytical techniques. For example, combinatorial chemistry is often employed to discover new lead compounds, or to create variations of a lead compound. Combinatorial chemistry techniques can generate thousands of compounds (combinatorial libraries) in a relatively short time (on the order of days to weeks). Testing such a large number of compounds for biological activity in a timely and efficient manner requires high-throughput screening methods which allow rapid evaluation of the characteristics of each candidate compound.

The quality of the combinatorial library and the compounds contained therein is used to assess the validity of the biological screening data. Confirmation that the correct molecular weight is identified for each compound or a statistically relevant number of compounds along with a measure of compound purity are two important measures of the quality of a combinatorial library. Compounds can be analytically characterized by removing a portion of solution from each well and injecting the contents into a separation device such as liquid chromatography or capillary electrophoresis instrument coupled to a mass spectrometer.

Development of viable screening methods for these new targets will often depend on the availability of rapid separation and analysis techniques for analyzing the results of assays. For example, an assay for potential toxic metabolites of a candidate drug would need to identify both the candidate drug and the metabolites of that candidate. An understanding of how a new compound is absorbed in the body and how it is metabolized can enable prediction of the likelihood for an increased therapeutic effect or lack thereof.

Given the enormous number of new compounds that are being generated daily, improved systems for identifying molecules of potential therapeutic value for drug discovery are being developed. Microchip-based separation devices have been developed for rapid analysis of large numbers of samples. Compared to other conventional separation devices, these microchip-based separation devices have higher sample throughput, reduced sample and reagent consumption, and reduced chemical waste. The liquid flow rates for microchip-based separation devices range from approximately 1 to 300 nanoliters per minute for most applications. Examples of microchip-based separation devices include those for capillary electrophoresis (“CE”), capillary electrochromatography (“CEC”) and high-performance liquid chromatography (“HPLC”) including Harrison et al., Science 261:859-97 (1993); Jacobson et al., Anal. Chem. 66:1114-18 (1994), Jacobson et al., Anal. Chem. 66:2369-73 (1994), Kutter et al., Anal. Chem. 69:5165-71 (1997) and He et al., Anal. Chem. 70:3790-97 (1998). Such separation devices are capable of fast analyses and provide improved precision and reliability compared to other conventional analytical instruments.

Still faster and more sensitive systems are being designed to provide high-throughput screening and identification of compound-target reactions in order to identify potential drug candidates. Examples of such improved systems include those disclosed in U.S. patent application Ser. No. 09/748,518, entitled “Multiple Electrospray Device, Systems and Methods”, filed Dec. 22, 2000, and U.S. patent application Ser. No. 09/764,698, entitled “Separation Media, Multiple Electrospray Nozzle System and Method”, filed Jan. 18, 2001, which are each herein incorporated by reference in their entirety.

Commercial systems in this field include capillary liquid chromatography systems, capillary chromatography columns, standard electrospray ion sources, and “pulled capillary” nanoelectrospray ion sources. “Pulled capillary” nanoelectrospray ion sources differ from standard electrospray ion sources, typically, in that the pulled capillary has a smaller diameter than the metal tube used as the electrode and fluid inlet in the standard source. This pulled capillary is typically usable for tens of samples before the performance degrades, and it is then discarded, as opposed to the metal tube of the standard source which is relatively stable and used on the order of hundreds of times without loss of performance. In both cases, the electrode and fluid inlet tube is manually coupled to the fluid tubing which delivers the sample.

Capillary liquid chromatography systems have been on the market for a number of years. These systems include an auto sampler that aspirates and then injects 20-100 nl volumes from 96 or 384 well plates, and a photodiode array for detecting the movement of analytes through capillary columns. These systems may be used with commercially-available columns with typical dimensions of 50-500 micron inside diameters and lengths of 5 to 25 cm. Capillary liquid chromatography (“LC”) systems integrated with mass spectrometers (“MS”) provide capillary LC/MS capability.

In capillary LC/MS, the injection is achieved by means of manually-made tubing connections between the auto sampler pipette, an injection valve, the chromatography column, and the ion source of the mass spectrometer. The injection is typically carried out by shunting a fluid segment into a defined length of small diameter tubing via a multi-port valve. Switching this valve transfers this loop of sample onto the inlet of the column and on to the mass spectrometer. The chromatography column is typically utilized for tens to hundreds of sample elutions before it is manually decoupled and disposed.

Relatively new options on the market are pulled capillary electrospray tips that the user may fill with chromatography medium. A porous frit inside the tip serves as an in-line filter to retain the medium from clogging the outlet of the tip. Also available are separate capillary columns that manually couple to pulled capillary electrospray tips. The capillary columns coupled to pulled capillary electrospray tips are not intended for one-time, carry-over free usage, or for usage in an automated fashion where one column is picked up, used in nanoelectrospray, and then discarded.

Other instruments have been commercialized for LC/MS using conventional electrospray ion sources and where flow rates are generally in the range of 50 uL/min to 1 mL/min or more. One instrument (Prospekt, Spark Holland Instruments, Netherlands) combines an auto sampler and conventional switching valves with disposable cartridges containing separation medium. Each cartridge is used once and then ejected. A rack or tray of cartridges introduces a new, unused cartridge for each sample through a clamping mechanism that allows the cartridges to be used at high flow rates and pressures of 3000 psi or more. Although the cartridge is used a single time all other components of the sample and liquid delivery system leading to the electrospray ion source, or other detector, are reused and therefore carryover of chemicals from one sample to the next remains a concern.

Carryover of trace amounts of sample from one run to the next run is a drawback of existing capillary LC systems that require a common fluid pathway of non-disposable elements (valve, sample loop, column, standard or pulled capillary electrode and fluid inlet to the mass spectrometer, and any associated tubing linkages). These elements must be thoroughly rinsed between sample runs to reduce the residual concentrations of prior samples. To totally eliminate carryover and the requirement to rinse the fluid-contacting elements of the capillary LC/MS system, the injector, column, and ion source electrode and fluid inlet, and any associated linkages must be single-use, disposable devices.

The potential in array size, high-throughput, and speed improvements over conventional technology that such devices offer can be facilitated with suitable automation of these devices. However, such automation can create a sample-loading bottleneck. Thus, there is a need for decreasing the time for loading and transferring a large set of fluid or dissolved samples into a sample detection system.

### SUMMARY OF THE INVENTION

One aspect of the present invention relates to a method for sample delivery, including attaching a first tube to a pipettor; aspirating a first sample into an outlet end of the first tube; pressurizing the first tube to deliver the aspirated sample from the outlet end of the first tube to an inlet end of a second tube, wherein the outlet end of the first tube is detachably connected to the inlet end of the second tube; and washing under pressure the first tube with solvent.

Another aspect of the invention relates to a method for chemical analysis, including attaching a first tube to a pipettor; aspirating a first sample into an outlet end of the first tube; pressurizing the first tube to deliver the aspirated sample from the outlet end of the first tube to an inlet end of a second tube containing separation media, wherein the outlet end of the first tube is detachably connected to the inlet end of the second tube; washing under pressure the first tube with solvent; and delivering under pressure elution solvent to the second tube.

Another aspect of the invention relates to a disposable tube including an inlet end and an outlet end, wherein the inlet end of a first tube is self-locking, self-aligning, self-mating, self-sealing and adapted to detachably engage an outlet end of a second tube.

Another aspect of the invention relates to a method for chromatographic separation in one or more dimensions utilizing one or more disposable columns including providing a single column or multiple columns detachably connected together, each column having an inlet end and an outlet end and filled with solid phase media; loading a column or multiple columns at the inlet end with at least one sample analyte; placing the outlet end of the column or multiple columns in fluid contact with an inlet of a detector; eluting the at least one analyte from the column or multiple columns to the detector; and detecting the at least one analyte.

Another aspect of the invention relates to a tube array including a plurality of tube holders adjacent one another; each tube holder including a passageway configured to receive a tube; wherein when filled with a tube, each passageway constrains the movement of the tube such that the tube has free movement along the tube axis but limited sideways movement of the tube, so that the tube is capable of being held in alignment with a corresponding device.

Another aspect of the invention relates to an automated sample handling system including an array of tubes at least partially pre-filled with sample and or mobile phase solution; a sample transfer device; and an automated fluid control system for loading at least one of the tubes of the array of tubes and actuating the sample transfer device; wherein the samples are dispensed from the tube array into a sample detection device.

Another aspect of the invention relates to a method for minimizing evaporation of sample, including loading at least one sample in a tube of an array of tubes, which array includes a plurality of tube holders adjacent one another, each tube holder including a passageway configured to receive a tube, wherein each passageway constrains the movement of the tube such that the tube has free movement along the tube axis but limited sideways movement of the tube, so that the tube is capable of being held in alignment with a corresponding device.

Other aspects of the present invention will be apparent to those skilled in the art from the following description and the appended claims.

### BRIEF DESCRIPTION OF THE DRAWINGS

FIG. 1 is a block diagram of a pipette tip-column assembly embodiment of the present invention;

FIG. 2 is a block diagram of a pipettor-column connection embodiment of the present invention;

FIG. 3 is a block diagram of a magazine-style feeding of tubes and columns embodiment of the present invention;

FIG. 4 is a block diagram of a three component multi-dimensional LC system;

FIG. 5 is a block diagram of a magazine-style feeding of tubes and columns embodiment employing a compact column-switching device;

FIG. 6 is a cross sectional view of a tube;

FIG. 7 is a perspective view of a scheme for molding a column;

FIG. 8 is a perspective view of an embodiment of columns molded with complementary inlet end and outlet end shapes for forming self-mating, self-aligning, self-sealing and detachable connections;

FIG. 9 is a schematic view of the (a) transfer of an elastomeric material from a transfer tape spooled on rollers and (b) transfer of an elastomeric material in a liquid form from a roller onto an electrospray device;

FIG. 10 is a schematic view of the opening up of vias in the elastomeric layer at the locations of the inlets shown in FIG. 9;

FIG. 11 is a schematic view of the formation of a gasket layer by a photolithographic method employing laser ablation and photo resist;

FIG. 12 is a perspective view of a single-level tube array in contact with a nozzle array chip;

FIG. 13 is a perspective view of a pipette administering both electric potential and a pneumatic head pressure to the fluid in the tube of a single-level tube array to provide an electrospray of the sample;

FIG. 14 is a perspective view of a multi-level tube array stack;

FIG. 15 is a perspective view of a pipette administering both electric potential and a pneumatic head pressure to the fluid in the tube of a multiple-level tube array to provide an electrospray of the sample;

FIG. 16 is a perspective view of a single-level tube array block with passageways that align the tubes to the nozzles of a sample transfer device and that allow restricted motion of the tubes along the tube axes;

FIG. 17 is a perspective view of a stack of tube array blocks which form a multi-level tube array with passageways that align the tubes to the nozzles of the sample transfer device and that allow restricted motion of the tubes along the tube axes;

FIG. 18 is a perspective view of one embodiment of a feature to restrain the tubes within the passageways of the block;

FIG. 19 is a side view of two tube array blocks before (left) and after (right) stacking and engaging the restraining feature (side clips in this embodiment);

FIG. 20 is a side view of one embodiment of a sealing design having tapered shapes at the tube ends;

FIG. 21 is a side view of a stacked multiple-level tube array showing a pipette filling and/or applying head pressure to the upper open end of a tube;

FIG. 22 is a perspective view of one embodiment employing a compressible gasket material between the tube ends of two adjacent blocks in a multi-block stack;

FIG. 23 is a side view of another embodiment employing a compressible gasket material between the tube ends of two adjacent blocks in a multi-block stack;

FIG. 24 is a side view of another embodiment employing a compressible gasket material between the tube ends of two adjacent blocks in a multi-block stack;

FIG. 25 is a perspective view of one embodiment showing a method for filling the tubes from a “starter” rack of tubes;

FIG. 26 is a perspective view of one embodiment showing another method for filling the tubes from a “starter” rack of tubes;

FIG. 27 is a perspective view of a filling tubing;

FIG. 28 is a perspective view showing the cutting of a pre-filled tubing; and

FIG. 29 is a perspective view showing a cover placed over the block to keep the samples cool.

### DETAILED DESCRIPTION OF THE INVENTION

One aspect of the present invention relates to a single tube for use in liquid chromatography. Another aspect of the invention relates to an array of tubes for rapid infusion of samples into a detector, and for liquid chromatography.

In both aspects, one or more tubes can be coupled together end to end without leaking. One or more tubes packed with solid phase media may serve as a separation column, such as a chromatography column. A tube upstream of the separation column can be used as a fluid transfer device. These single tube and block array tube aspects of the invention share some common methods and provide some common benefits, but also have differences in method and yield some differences in benefits. From a design perspective, an important feature common to both aspects of the invention is the ability to form good tube-separation column and separation column-detection device sealing.

From a method perspective, an important feature common to both aspects of the invention is that the tubes and separation columns are disposable, self-mating, self-sealing, self-aligning, detachably connectable, and eliminate carryover. The present invention provides the total elimination of carryover by employing single-use disposable elements wherever fluid is in contact with a surface, for example, the injector, separation column, and ion source electrode and fluid inlet, and any associated linkages. An automated system employing such a disposable injector, separation column, and ion source electrode and fluid inlet, and any associated linkages is accomplished by the self-mating, self-sealing, self-aligning, detachably connectable nature of these elements in an automated fashion.

In the single tube format, each separation column is used independently and is not pre-assigned to, for example, a particular nozzle in a nozzle array of a spray device. In this format, any given separation column may be used with any nozzle or nozzles in any sequence, including nozzles on different spray chips and including spray chips having different formats. Moreover, some nozzles on a given spray chip can be used with separation columns for chromatographic separations, while some can be used for simple transfers or “infusions.” This provides flexible scheduling of sample processing through separation columns and nozzles that are independent of the order in which spray chips and their nozzles are used. The independence of separation column and nozzle usage is easily made possible because an automated system can reliably align one separation column at a time with one nozzle. For an array of separation columns, the alignment of a plurality of separation columns with a plurality of nozzles is simultaneously achieved and column and nozzle usage are not independent.

In one embodiment, the user may flexibly and spontaneously select from different devices that introduce liquid samples into the spray chip because the disposable chromatography columns for on-line elution are separate from, for example, a nanoelectrospray chip and are interchangeable with disposable sample transfer tubes for mere infusions (i.e., sample is transferred to the detector without elution through a solid phase medium). The user can select from a sample transfer tube for infusion or a disposable separation column for on-line elution. The user can choose to use any particular nozzle differently from the others on the spray chip, and choose to use each nozzle as he sees fit at the time. Furthermore, compact separation column-switching device can be actuated whenever it is needed for performing multi-dimensional separations, and then de-actuated for use without separation column-switching capability. The column-switching device may also be employed in conjunction with an array of tubes, where the array provides the second column of a multi-dimensional separation, and the first column is a single separation tube.

The system also supports high sample throughput and minimizes the time that the detector is idle by efficiently handling the separation columns and samples. The design of the system components provides a low cost disposable separation column that accurately aligns and seals the column or multiple columns with the elution and detection fluid connections of the system. The disposable column is filled with a separation media, preferably solid phase media, polymer, or silica beads (which typically require one or more frits). Preferably, the inside diameter of the separation column ranges in size from about several microns to about 1000 microns, preferably from about 5 microns to about 500 microns. The tubes of the present invention are particularly suited for micro-fluidics, however, they may also be sized to accommodate larger volumes and flow rates. The tubes of the present invention are not restricted in length. Preferably, each tube has a length of from about 1 cm to about 20 cm. The foregoing dimensions enable a sample flow time suitable for sample separation and delivery, preferably from about 30 seconds to about 5 minutes per sample.

The detector can be any device known in the art that detects chemical species and includes a chemical analyzer such as MS or other detector known in the art of LC. The detector system preferably includes an electrospray device in combination with a MS.

The design of the system components, particularly the modular, self-mating, self aligning, self-sealing, and detachable transfer tubes and separation columns, and the miniaturized column-switching device that is designed for automated coupling to a first column (upstream) and a second column (downstream) also enables multi-dimensional separations.

Another aspect of the present invention relates to an array format for a plurality of tubes. In the tube array format there is a plurality of tube holders adjacent one another. Each tube holder has a passageway configured to receive a tube. Each passageway constrains the movement of a tube in the array: allowing free movement of the tube along the tube axis, while allowing limited sideways movement of the tube. In this manner the tube is held in alignment with a corresponding device, for example, a corresponding input port of a sample transfer device.

Another aspect of the present invention relates to an automated sample handling system which includes an array of tubes pre-filled with sample; a sample transfer device; and an automated fluid control system for pre-filling the tubes and actuating the sample transfer device; wherein the samples are introduced from the tube array into a sample detection device.

In another embodiment, the present invention relates to one or more tubes configured for single or multiple one-dimensional separations and multi-dimensional separations. The tubes may be applied one at a time as single tubes or in parallel as a tube array. The tubes may be internally free of or contain separation media depending upon experimental protocol and their placement in the fluid stream.

The present invention provides a variety of benefits with respect to LC. The tubes may be used as disposable chromatography columns or as disposable sample transfer tubes. The tubes are effective to eliminate carry-over (the presence of trace levels of previously eluted analytes present in subsequent elutions from the same column) when used either as sample transfer tubes or as chromatography columns. The tubes improve the automation of LC by enabling unassisted, computer-controlled elutions on a series of samples provided, for example, in a 96 or 384 or other micro plate format. Automation of LC optionally includes all or some of the following steps and capabilities: the pick-up of a sample from a micro plate, the loading of the sample into a column, the washing of the column, and the isocratic or gradient elution of the retained analytes directly into a detector. This detector may preferably be a mass spectrometer, wherein the ionization of the sample analytes is effected by a chip-based nanoelectrospray device, including a plurality of nanoelectrospray nozzles in an array format. The separation columns enable automated multi-dimensional separations.

Furthermore, in an array format, the present invention decreases the time for loading and transferring a large number of fluid or dissolved samples into a sample detection system.

By way of illustration, two processes of the present invention include the use of a single separation column system for one-dimensional separation. One process employs disposable transfer tubes to eliminate “sample carryover” from an automated pipettor to any downstream device that the pipettor makes contact with, particularly the columns in a separation procedure or the spray chip in an infusion procedure. In the other process, disposable transfer tubes are not used, rather, thorough rinsing of the tube holder or pipettor is used to eliminate carryover.

A pipettor is a device which creates positive and negative pressure so that small amounts of liquid are drawn into a narrow tube for transfer or measurement. Commercial pipettors such as Hamilton, Eppendorf, and BrandTech are available from the distributor Cole-Parmer, for example.

Additionally, these processes can each be carried out in one of two modes of fluid handling: the “flow through” and “aspirate and dispense” modes. In the “flow through” mode, the pipettor serves as a pipe through which fluid phases pass from a container and into the separation column. In the “aspirate and dispense” mode, the pipettor is used to sequentially apply suction and then head pressure to aspirate a fluid phase from a container into a tube or separation column, and to drive that aspirated fluid through the separation column, respectively. In this mode, carryover of analytes from one fluid to the next is eliminated by disposal of all fluid-contacting materials. In the “flow through” mode, some fluid-contacting materials are rinsed between fluids to minimize carryover.

Initially, the samples to be analyzed are contained in the wells of a micro plate having, for example, 96 or 384 or other amount of wells. In accordance with the present invention, the term “transfer tube” or “tube” means a tube without separation media inside that is capable of functioning as a pipette tip, but which may have an unconventional shape. For example, a separation column may have a cylindrical shape and preferably has specially shaped ends. Tubes with shapes like these may serve as sample transfer tubes when they are not filled with solid phase separation media. A series of tubes may be interconnected by self-mating, self-aligning, self-sealing, and detachable connections. The upstream-most tube may not contain separation media and serve as a transfer tube, while the subsequent tubes downstream of the first tube may be filled with specific solid phase separation media and serve as chromatography columns. The tubes compose an easy-to-use modular system to eliminate carryover via the disposable transfer tube.

This modular system enables columns of different lengths to be formed by stacking multiple shorter tubes together. Additionally, two or more separation columns of different solid phase media can be coupled directly together to enable Multidimensional Protein Identification Technology (“MudPIT”)-style multi-dimensional LC. In MudPIT, columns containing two different types of solid phase media (e.g., strong cation exchange vs. reversed phase) are connected together in series. Alternating the flow of a first solvent that elutes analytes off of the first column with a second solvent that elutes analytes off of the second column, yields two dimensions of separation without the use of column switching. The composition of the first solvent is varied in a step-wise fashion. For each step in the gradient of the first solvent, a continuous gradient elution is performed in the composition of the second solvent.

Standard multi-dimensional LC is enabled by a column-switching device described below which is compatible with these tube and separation column designs, including the use of an array of tubes as the second column of a multi-dimensional separation. For isocratic separations, the elution buffer may be entirely contained within the transfer tube to eliminate carryover, the need for fluid flow through the pipettor, and the associated additional fluid, tubing, and rinsing steps.

Step (1). If required, the sample clean up is performed first. In a preferred embodiment, sample clean up is performed by solid phase extraction or the like. A pipettor with one or more heads transfers the samples to the wells of a solid-phase extraction (SPE)-style micro plate. If this SPE micro plate has fewer wells than there are sample wells in the source plate, the samples can be distributed across more than one SPE micro plate. The analytes retained by the SPE media are eluted from the individual SPE wells and transferred into corresponding inlets of individual separation columns. In one embodiment, the outlets of the SPE micro plate are configured to be self-mating, self-aligning, self-sealing, and detachable with the separation columns held in a corresponding tray (i.e., in the same micro plate format as the SPE plate). In another embodiment, the outlets of the SPE micro plate deliver the analytes into a corresponding micro plate. In this case, transfer of the samples from the micro plate to the separation columns is performed by a pipettor. The disposable tips of the pipettor are the self-mating, self-aligning, and self-sealing tubes of the present invention, which are detachable with the separation column held in a corresponding tray. This process is the same as in the case when sample clean up is not required; a pipettor is used to transfer the samples directly from the source micro plate into the separation column in a micro plate-format tray. Other procedures which require sample clean up include protein precipitation and centrifugation, liquid-liquid extraction, and filtration. In all of these cases, the use of tubes having self-mating, self-aligning, self-sealing, and detachable connections between a source of analytes and the inlet of the separation column constitutes a disposable injector for chromatography and sample analysis that eliminates carryover.

Step (2). Depending on the sample, an additional wash step may be performed on the analytes retained on the columns. Wash buffer is driven through the separation columns by either positive pressure or by vacuum, in a single- or multi-well washing apparatus. Prior to the wash, pressure or vacuum may be applied to bring the sample fluids from the inlets of the separation columns fully into the solid phase media within each column. These columns may optionally be formed by coupling together two or more different tubes containing different solid phase media for a MudPIT-style multi-dimensional separation. For a “standard” multidimensional separation (i.e., non-MudPIT style), the samples are driven into the first column only, and the second column is coupled to the first via a compact column-switching device like that described below.

Step (3). When the samples have been sufficiently prepared and the loading of the separation columns has been completed, the retained analytes are eluted by flowing solvents through each column to the detector (for a one-dimensional separation or for a MudPIT-style multi-dimensional separation) or to a column-switching device coupled to a second column (for standard multi-dimensional separation). The detector is preferably a mass spectrometer utilizing a nanoelectrospray chip for sample ionization and introduction.

Step 3(a). In the “aspirate and dispense” mode of fluid handling, one or more pipettors (preferably each holding a tube to eliminate carryover) aspirates elution solvent prior to picking up one or more separation columns. In the “flow-through mode” of fluid handling, one or more pipettors (preferably each holding a tube to eliminate carryover), picks up one or more separation columns without aspirating elution solvent, because the pipettor is in fluid connection with the elution solvent. The “aspirate and dispense” mode is not preferable for performing gradient elutions, although crude step-gradients may be set up within a tube with a narrow inside diameter, by sequentially aspirating solvents of different composition to form a “stack” of different fluid segments within the tube.

Thus at this stage of the process, the elution solvent has been measured into a second disposable, self-sealing, self-aligning, self-mating injector (the online-injector). The next step is to inject this solvent into the separation column.

Step 3(b). The pipettor moves the separation column from its tray to a nozzle (or group of nozzles) on the nanoelectrospray chip. Flow is induced to elute the analytes into the detector. For a standard multi-dimensional separation, a column-switching system like that described below is placed between the first separation column and the detector. For a MudPIT-style multi-dimensional separation, additional columns are coupled directly downstream of the first column and upstream of the detector.

Step 3(c). The flow rate and the composition of the elution solvent are controllable and may be programmed to respond to the detected signal. Thus, isocratic and gradient elutions as well as peak parking are enabled by this invention. Higher throughput may be achieved by employing multiple pipettors to present multiple separation columns to the spray chip in rapid sequence, so that while one pipettor is moving, another one is effecting nanoelectrospray into the detector. When the elution from one column is finished, it and any attached tube (in the case of the first procedure) are discarded. Then the pipettor picks up the next separation column to start the next elution. Low flow solvent gradients may be formed by mixing the output of two programmable syringe pumps and pushing the output through the pipettor to the separation column. Structures or devices for mixing the two fluidic streams may be located inside or outside of the inner channel in a pipettor that holds the tube or separation column.

The transfer of the micro plate-format tray of separation columns from step 1 to step 2 and from step 2 to step 3 may be performed by a robotic arm or equivalent automated system in accordance with procedures known in the art. Bar-code readers and computers keep track of the movement of micro plates and samples through the system, and correlate the identity of each sample with its subsequent experimental conditions and resulting data. The separation columns themselves may be coded by color or markings and read to allow the tracking of samples through the system.

In an alternative embodiment which achieves faster automatic sample handling, the robot employs two or more magazine-like devices to feed fluid-loaded tubes or columns into a trough in which the pipettor is guided to drive the tubes and separation columns forward against a retractable stop, forming a tightly-sealed composite tube-column device. These tubes or columns may be fed into the tube and column handling mechanism by a single belt or ribbon on which individual tubes or columns are initially attached at even intervals, and then readily and individually detached by the pipettor for each sample. Next, the stop is retracted and the pipettor drives the tube-column device forward into fluid connection with the spray chip. After the sample has been analyzed, the probe retracts and the composite tube-column device is rapidly removed. A tube ejector is built into the end of the pipettor to minimize the time required to remove a tube-column device. The process is then repeated.

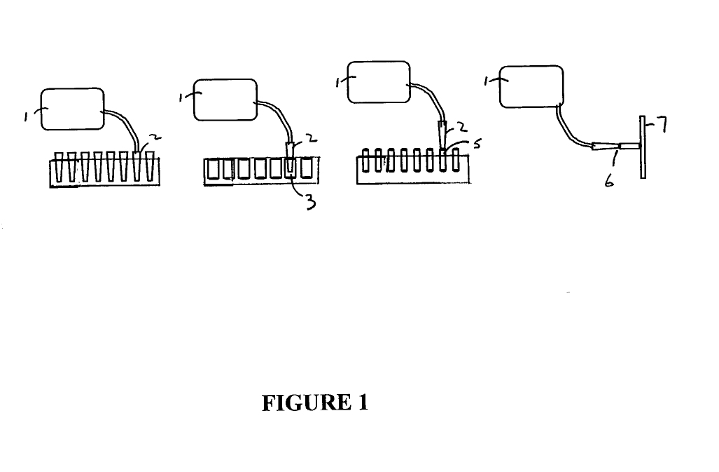

Referring to FIG. 1, shown is a block diagram of a first embodiment of the system. In offline processing (not shown), samples from a micro plate having 96, 384, or other number of wells of sample are transferred by a pipettor to an SPE plate. The samples are cleaned using an SPE or the like, then transferred by vacuum or pressure driven flow into a tray of separation columns. The unbound solutes are washed through the separation columns. A pipettor 1 is used to pick up a new pipette tip 2. Elution solvent 3 is aspirated into pipette tip 2 by pipettor 1. Pipettor 1 connects to and picks up one or more sample loaded separation columns 5, and forms pipette tip-column assemblies 6. Bound solutes in column 5 are eluted with elution solvent 3 into nanoelectrospray MS 7. The process is then repeated for the next pipette tip 2 and separation column 5, as desired.

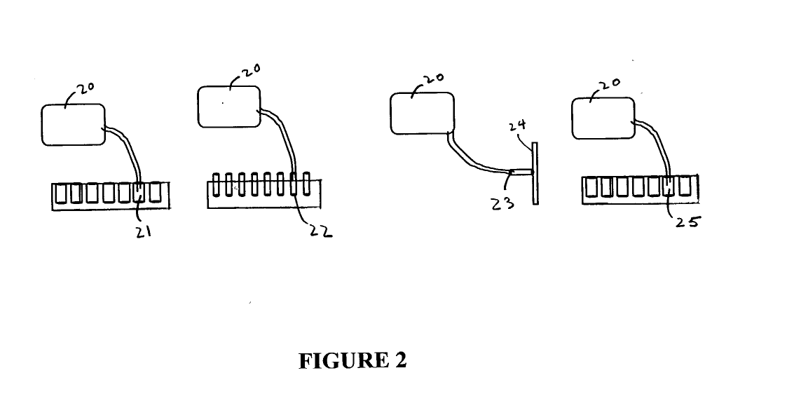

Referring to FIG. 2, shown is a block diagram of a second embodiment of the system. In offline processing (not shown), samples from a micro plate having 96, 384, or other number of wells of sample are transferred by a pipettor to an SPE plate. The samples are cleaned using an SPE or the like, then transferred by vacuum or pressure driven flow into a tray of separation columns. The unbound solutes are washed through the separation columns. One or more pipettors 20 aspirate elution solvent 21 and are connected to and pick up one or more separation columns 22 to form pipettor-column connections 23. Column 22 bound solutes are eluted with elution solvent 21 into a nanoelectrospray MS 24. The end and channel of the pipettor 20 are rinsed with solvent 25 to eliminate carryover. The process is then repeated for the next samples and separation column 22.

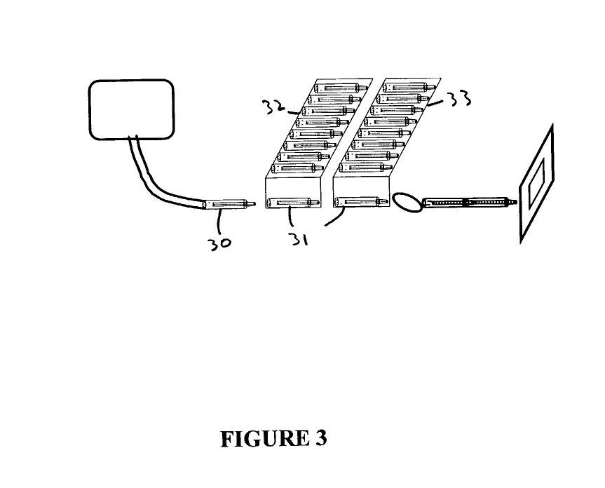

Referring to FIG. 3, shown is an embodiment employing magazine-style feeding of tubes 30 and separation columns 31 from magazine A 32 and magazine B 33, respectively.

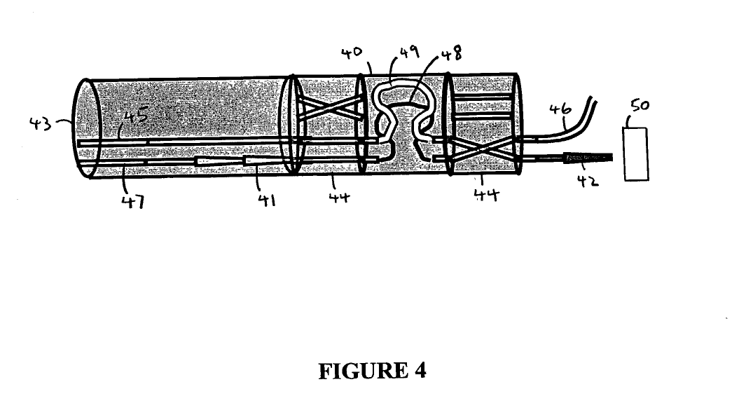

Referring to FIG. 4, standard-mode of multi-dimensional separations in a compact format, non-MudPIT-style, are enabled by a compact column-switching device 40 located between a first separation column 41 and a second separation column 42. A preferred embodiment employs a cylindrical valve housing 43 with one cylindrical rotating switching valve 44 at each end of the housing 43. In this device, the sample loops are contained within a block or cylinder located between the two end valves. The two end valves rotate in unison to simultaneously switch the connections to the sample loops at both the upstream and downstream ends, to effect the fluid flow switching shown in FIG. 4. The design of this switching valve can be extended to switch the flow between 2 or more columns and enable chromatographic separations in 2 or more dimensions. At its upstream end, the housing 43 connects to the first separation column 41 and to a source of the elution solvent 45 for the second separation column 42. At its downstream end, this valve housing connects to the second separation column 42 and a waste container 46. In one position of the valve 44, the first elution solvent 47 flows from the first separation column 41 into a first loop 48 and then to waste 46, while the second elution solvent 45 flows into the second loop 49 and then into the second separation column 42 and into the nanoelectrospray chip 50. In the other position of the valve 44, the first loop 48 is brought in line with the flow of the second elution solvent 45 and second separation column 42, while the second loop 49 is brought in line with the flow from the first separation column 41 and into the waste container 46. The valve 44 is switched at a regularly timed interval to segment the eluent from the first separation column 41 into fractions held alternately in the first loop 48 and the second loop 49 of the device. In this time interval a rapid gradient elution of an entire fraction from one of the loops 48, 49 may be effected through the second separation column 42.

Referring to FIG. 4, three components of a multi-dimensional LC system are shown: a dual channel rear cylinder assembly 43 with a first separation column 41; a switching valve assembly 44 with dual loops 48, 49; and a single-channel front cylinder with a second separation column 42.

This switching valve is formed in a compact shape by building the two sample loops into the valve that are each longer than the external dimensions of the valve. These loops may be formed within the valve housing by tubing wound into coils, or by fabrication of a solid containing intertwined serpentine or helical or spiral fluid channels.

Additionally, this compact column switching device is compatible with the design of an automated system that picks up a tube from a tray and drives it horizontally against a spray chip, or with a gun-mode tube and column handling system that employs magazine-style loading of tubes and separation columns and drives tube-column assemblies against a chip. In these cases, the design of the tube and column handling mechanism is extended to drive the first separation column against the column-switching device, and the column-switching device against the second separation column, while the entire column switch column assembly is driven against the spray chip. Alternatively, the column-switching device is driven against the second separation column, then the first separation column is driven against the switch-column assembly, and then the entire system is driven against the spray chip. Other alternative methods of combining the column switching device with the two separation columns and the spray chip will be apparent to one skilled in the art.

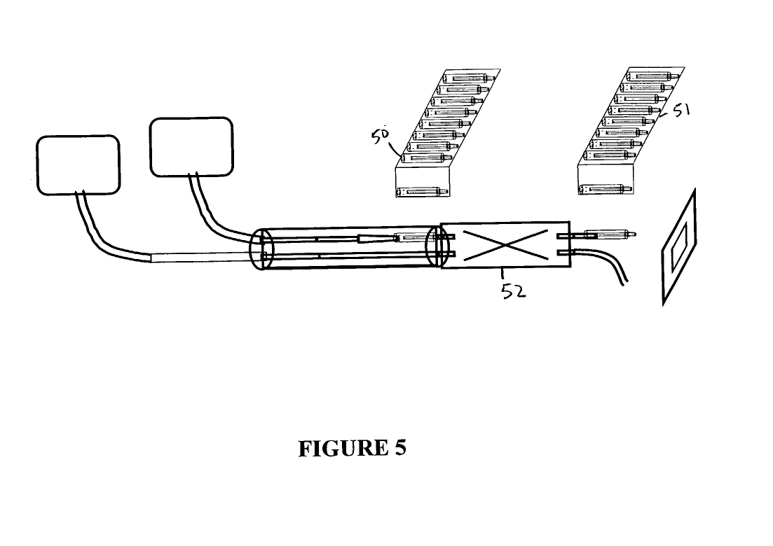

Referring to FIG. 5, shown is an embodiment employing magazine-style feeding of tubes and separation columns from magazine A 50 and magazine B 51, with the compact column-switching device 52 installed.

In one embodiment, the separation column is packed with a polymer monolith in the downstream portion of the separation column, and a conventional porous silica particulate medium packed in the upstream portion of the separation column. This allows more analyte to be trapped in a tight band at the upper end of the separation column, while lowering the overall required head pressure compared to a separation column filled completely with traditional porous particulate media. The polymer monolith also serves as a frit at the lower end of the separation column. Additional monolith may be formed above the porous particulate media to serve as an upper frit.

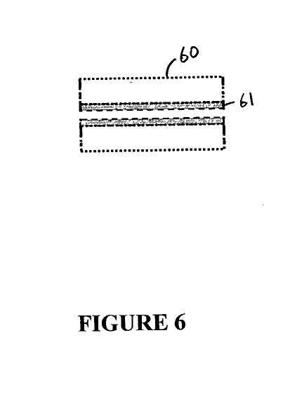

In this embodiment, the separation column has a small internal diameter (“ID”) (about 1 mm, suitable for low flow rate chromatography) is substantially straight, rigid, and amenable to automated handling. Thus, it preferably has a reasonably large outer diameter (“OD”) (about 2 mm), or it may have a large OD hub. One example of a suitable tube for use as a separation column is a medical-style hypodermic needle, commercially available with very fine ID and a plastic hub suitable for mounting on the end of a pipettor and forming a tight fluid connection. In another embodiment, the column may be formed by co-extruding or injection molding a tube of larger ID (about 2 mm) around a small ID (about 1 mm) and moderate OD (about 1-2 mm) extruded tube, see FIG. 6. Referring to FIG. 6, a tube 60 having a large OD is formed around a tube 61 having a small ID. The outer layer of material may be softer than that of the inner tube, to enable sealing of the column to the spray chip.

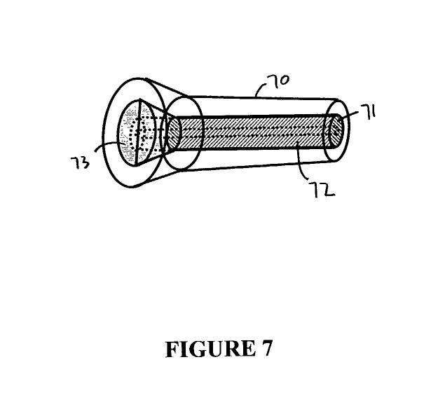

When injection co-molding about a small ID extruded tube (as in the second embodiment), a “core pin” may be used. A core pin is a pin that extends into the mold cavity to accurately position a co-molded part such as this extruded tube. It can also ensure that the fine passageway in the tube is not collapsed under the high pressure and temperature that may be used in the mold. Alternatively, because the placement of the extruded tube on a core pin increases the cost to make the part, the mold cavity may have a cone-shaped holder in which the inner tube may be held without the use of a core pin. Referring to FIG. 7, a scheme is shown for molding a column 70 with a small internal diameter (less than about 0.5 mm) by using an inserted tube 71 without a core pin. The hashed region 72 on the right is the inserted extruded tube to be co-molded and the gray-shaded region 73 on the left is the portion of the mold that holds this tube. The conical shape of this tube-holding protrusion on the mold base is compatible with the dispensing end of a pipettor. This yields a finished part with a back-end shape that can mate securely with the dispensing end of a pipettor. The material of the over mold may be softer than that of the inserted tube, to facilitate sealing of the column against a surface.

In a third embodiment, the entire tube is injection molded to a large OD, while a small ID channel is formed by a fine core pin inserted into the mold cavity.

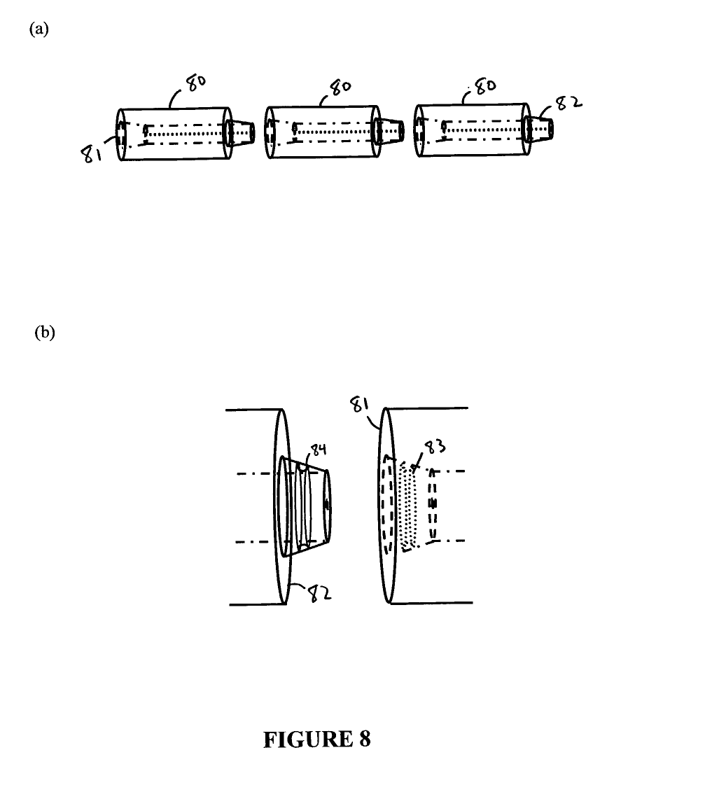

For any injection molding process, the material may be shaped according to known methods for self-mating, self aligning, self-sealing, and detachable connections to form a good sealing “snap-fit” between separation columns or between tubes and separation columns. For example, referring to FIG. 8(a), shown are columns 80 molded with complementary inlet end 81 and outlet end 82 shapes for self-mating, self aligning, self-sealing, and detachable connections. Two or more of these tubes coupled together forms a tube-column, column-column, or tube-column-column assembly, and the like. Referring to FIG. 8(b), shown is a detailed embodiment of the self-mating, self aligning, self-sealing, and detachable connection having an annular boss 83 on the inside of the inlet end 81 of the connection that is matched by an annular groove 84 on the outside of the outlet end 82 of the connection.

For separation columns that are made of hard materials such as glass, steel, polyether ether ketone (“PEEK”) plastic, and the like, the sealing of the column to the chip may be enhanced by forming a soft elastomeric layer on the back of the spray chip. The sealing of an array of separation columns to the chip may also be enhanced by such a soft elastomeric layer on the back of the spray chip.

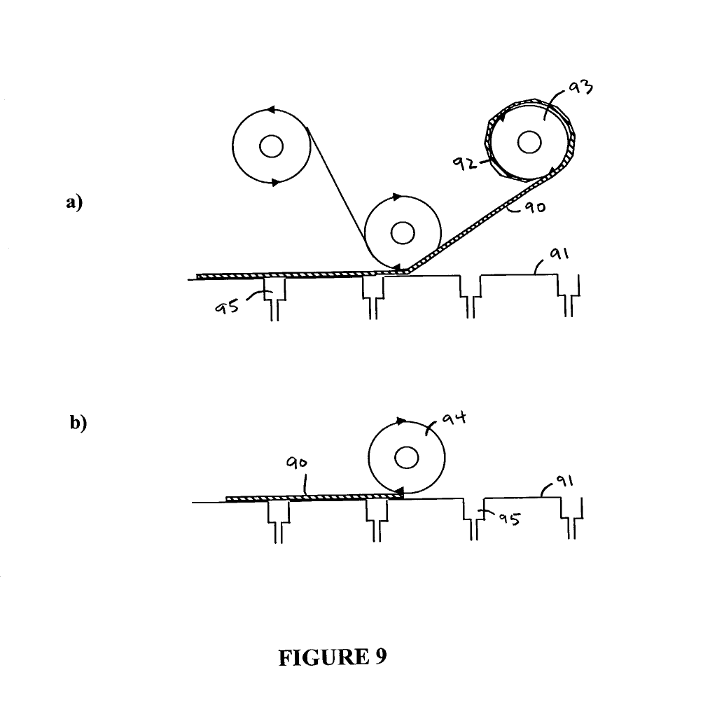

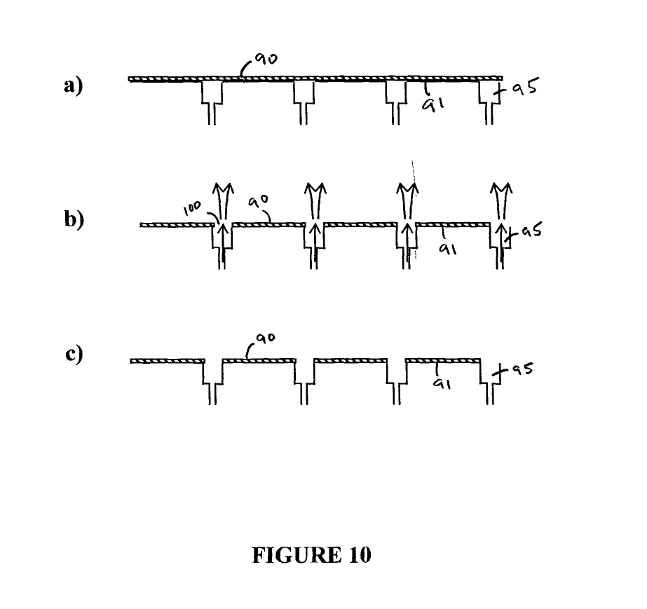

In one embodiment, a preformed elastomeric sheet 90 is aligned and placed on the back of the spray chip 91. In another embodiment, various forms of contact printing can be used to form an elastomeric layer. Referring to FIG. 9, scheme (a) shows the transfer of an elastomeric material 90 from a transfer tape 92 spooled on rollers 93. Scheme (b) shows the transfer of an elastomeric material 90 in a liquid form from a roller 94. Suitable application methods include transfer tape, applying a liquid elastomeric “ink” by a roller or, similarly, flexographic printing, and screen printing. When the elastomeric layer is initially applied over the nozzle channels 95 (not the case in screen printing), “vias” in the elastomer may be opened up by applying air pressure from the front side of the spray chip 91 while the elastomer is in a liquid or low viscosity state. FIG. 10 shows the opening up of vias 100 in an elastomeric layer 90 on the spray chip 91 at the locations of the entrances to the nozzle channels 95. If the initially applied layer is too viscous for opening vias by air pressure at room temperature, the viscosity of the layer may be lowered by heating.

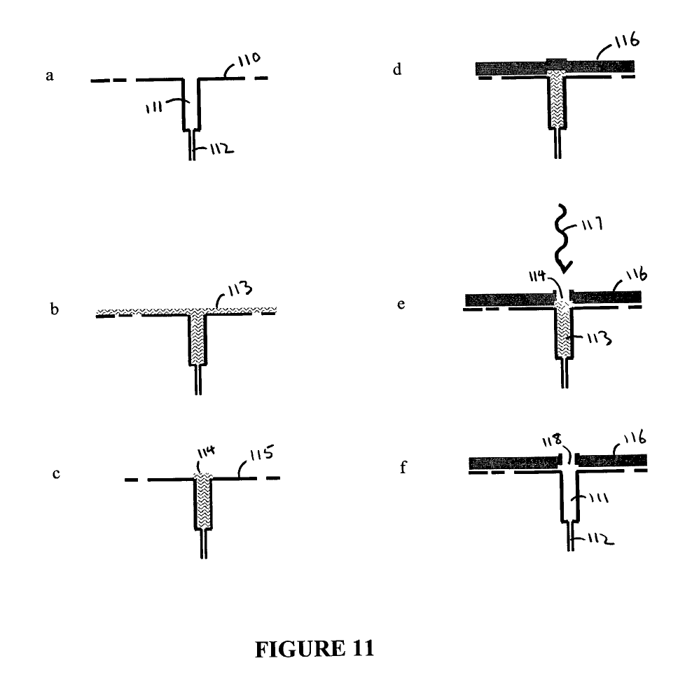

In another embodiment, the elastomeric material is spin-coated and then patterned by photolithography or laser ablation. Referring to FIG. 11, formation of a gasket layer by a photolithographic method employing laser ablation and photo resist is shown. FIG. 11 shows the profile of the back side of an electrospray ionization device 110 or other sample transfer device, showing an inlet 111 of a larger diameter leading to a narrow channel 112 of smaller diameter. The back side 110 of the device is coated with a positive photo resist 113. The inlet area 114 for each die are masked. The photo resist 113 is developed and washed away where the photo resist 113 is not masked 115. An elastomeric layer 116 is formed over the back side of the device 110. The inlet areas 114 of each die are laser ablated with laser irradiation 117 to remove the elastomeric layer 116. It is not necessary to laser-ablate all of the undeveloped photo resist in these areas. The exposed photo resist 113 is developed and washed away, leaving a clean via 118 through the elastomer 116, inlet 111, and channel 112 into the device 110 that is free from contamination with either elastomer 116 or photo resist 113.

In a second embodiment, an array of tubes is placed in a block and can be used in conjunction with the corresponding nozzles of a spray chip which can be sealed against this array of tubes. The array system decreases the time for loading and transferring a large set of fluid or dissolved samples into a sample detection system, such as a mass spectrometer, and thereby reduces the time that the sample detector is idle between the measurements of successive samples. The time required to detect and analyze a set of many samples is correspondingly reduced. This system also provides an automated, flexible, user-configurable micro-scale chromatography array system for separation processes on complex fluid mixtures and solutions.

The system includes an array of tubes that are pre-filled with samples, a sample transfer device, and robotic fluid control systems for pre-filling the tube array and for actuating the sample transfer device, thereby introducing the samples from the tube array into a sample detection system. The inside of the tubes may optionally be coated or packed with material for effecting chromatographic separation of solutes in the samples. This system also enables construction of multi-level arrays of extended columns by stacking multiple single-level tube arrays.

This present invention eliminates a sample-loading bottleneck when using a sample detection system such as a mass spectrometer. The time to detect one sample can be as short as 0.5 minutes per sample, but with conventional systems there is typically a time delay of greater than one minute between the detection of one sample and the loading of a second sample. During this time, the detector is idle and waiting for a sample to be loaded for transfer to the detector. The present invention makes it possible to largely eliminate the idle time of the detector by decoupling the two stages of sample analysis—(a) the loading of samples (96, 384 or more samples) into a format that enables rapid sample transfer and (b) the transfer and detection of the samples. That is, multiple samples can be loaded into corresponding multiple tubes of the array, while sample transfer can be taking place from other tubes that have already been loaded with samples. The elimination of the sample-loading bottleneck can be achieved during the processing of a single block array (i.e., loading and transferring by subsets of tubes within a single block array), or between successive entire block arrays (i.e., by loading one entire array prior to transferring samples into the detector from that entire array).

In a first example, in the case of a block array of 96 samples, processing samples by a 24 tube subset would proceed as follows: while samples in the first 24-tube subset are being transferred and detected, the next 24-tube subset is being loaded with samples. Transfer of tube subsets from a sample loader to a sample transferring device would occur at approximately 12 minute time intervals, assuming that 0.5 min. is required to detect each sample. After 4 rounds of transfer of 24 tubes each, one entire 96-tube block would be completed, and a second 96-tube block could be started.

In a second example, in the case of a block array of 96 samples, processing samples by whole block arrays would proceed as follows: while samples in the first 96-tube block are being transfer and detected, the next 96-tube block is being loaded. Transfer of whole blocks of tubes from a sample loader to a sample transferring device would occur at approximately 48 minute time intervals, assuming that 0.5 min. is required to detect each sample.

From about one to about five minutes per sample can be expected to be saved by this method, or from about 1.6 to about 8 hours when running a set of 96 samples. These examples can be extended to block arrays of 384 or more samples, and array subsets of 4, 6, 12, 36, 48 or more tubes.

This system eliminates the carry-over of sample from one tube and/or one sample transfer device (an electrospray device in mass spectrometry, for example) that would occur if several different samples were being transferred through the same fluid pathways. By contrast, in this system, only one sample is contained or transferred through each tube and/or sample transfer device.

Another aspect of the invention relates to minimization of evaporation of small sample volumes by holding the liquid samples inside of small internal diameter tubes. Evaporation is minimized in these tubes by the minimization of the sample surface area corresponding to a liquid-vapor interface, and the maximization of the sample surface area corresponding to a liquid-solid interface. This system minimizes the amount of sample required for processing but still yields a high sensitivity. The ability to process small volumes of sample also provides the advantage of minimizing evaporation of sample.

This system enables 2D chromatography in a compact and convenient manner such as that disclosed in U.S. patent application Ser. No. 09/764,698, entitled “Separation Media, Multiple Electrospray Nozzle System and Method,” filed Jan. 18, 2001, which is incorporated by reference herein in its entirety. By using a sequence of different separation media high theoretical plate values may be achieved from separation columns of short length that yield short retention times. Suitable separation media, which is defined as solid material used to pack a separation column and effect differential elution of analytes in liquid chromatography, includes ion-exchange, affinity, size-exclusion, reversed-phase separation media, and the like.

The manufacture of the blocks and tubes and the filling of the tubes with stationary phase material are facilitated by making the tubes separately from the block. It is relatively difficult to manufacture a block of significant thickness t (t about >5 mm) with an array of through holes of very small inner diameter, (ID about <0.5 mm). By contrast for this system, it is relatively less difficult to manufacture tubes of length l (l about >5 mm) with very small inner diameter (ID about <0.5 mm) and moderately sized outer diameter (OD from about 0.5 mm to about 2 mm).

It is also relatively difficult to pack or fill a large number of very short, narrow tubes with separation media, compared to packing or filling a very long tube with separation media. For this system, by cutting up a longer packed tube, many shorter packed tubes can readily be made. The resulting shorter packed tubes are then also more uniformly and completely filled with separation media.

This system includes an array of tubes for the transfer of liquid samples into a sample detection system, preferably a mass spectrometer. The tubes of the array may either be free of internal coatings and material, or they may be internally coated or filled with one or more internal materials for facilitating chromatographic separations (separation coatings or media). The tubes of the array may then be brought into contact and fluid communication with a sample transfer device. This sample transfer device may preferably be an electrospray device having an array of corresponding nanoelectrospray nozzles (a nozzle array chip). In general, the sample transfer device may deliver fluid contents of the array to any kind of sample detection system. By stacking these tube arrays, this system may also include an array of multi-level tubes in which each multi-level tube forms an extended chromatographic column. This system includes a method to apply head pressure and/or electric potential to one or more selected tubes of the array, thereby actuating sample transfer into the sample detection system. Preferably, the system applies head pressure and/or electric potential to initiate electrospray into a mass spectrometer. Taken together, this system is an automated, flexible, user-configurable micro-scale chromatography array system for separation processes on solutions of complex mixtures, and for chemical analysis and detection by mass spectrometers or for transfer to other sample detection systems.

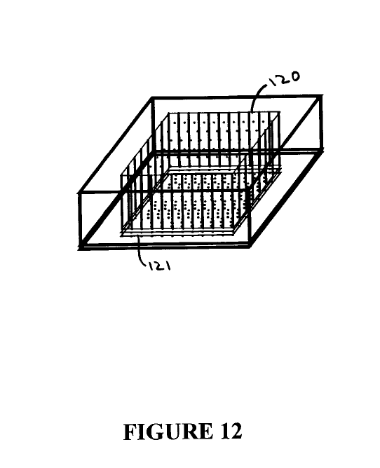

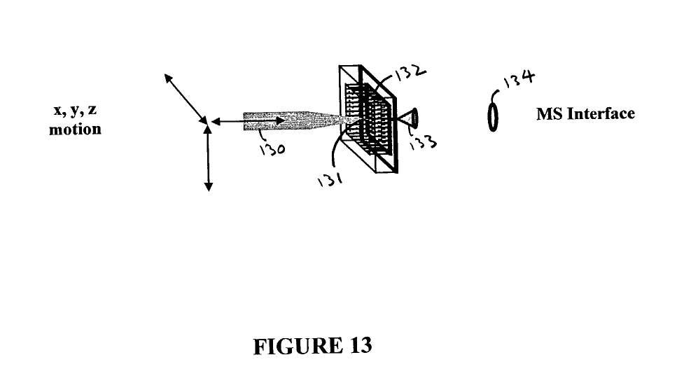

In a preferred embodiment, the sample transfer device is an electrospray nozzle array chip. FIG. 12 shows a single-level tube array 120 in contact with a nozzle array chip 121. In accordance with this embodiment as shown in FIG. 13, a robotic pipettor 130 (or the like) is brought into contact with the open end of one tube 131 at a time, and presses the tube 131 tightly against the chip 132, thus forming seals at the tube-chip and tube-pipette junctions. At the same time, the pipette administers both an electric potential (voltage) and a pneumatic head pressure, thus initiating electrospray 133 at one nozzle into MS 134 for one sample at a time. Additionally, for separations, the pipette may administer an elution solvent, whose composition may be held constant or may be varied as in a “gradient” elution.

Thus, the types of processes enabled by this device and system include those that require or benefit from separation media within the tubing, and those that do not require separation media. For a separation process, elution is enabled by the capability to inject 1 micro liter or more of one or more mobile phase solvents, or mobile phase solutions with a time-varying composition or gradient profile, into the open end of each tube in the array.

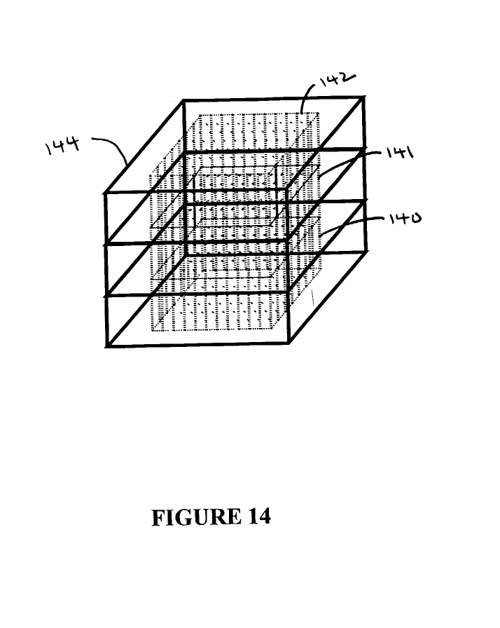

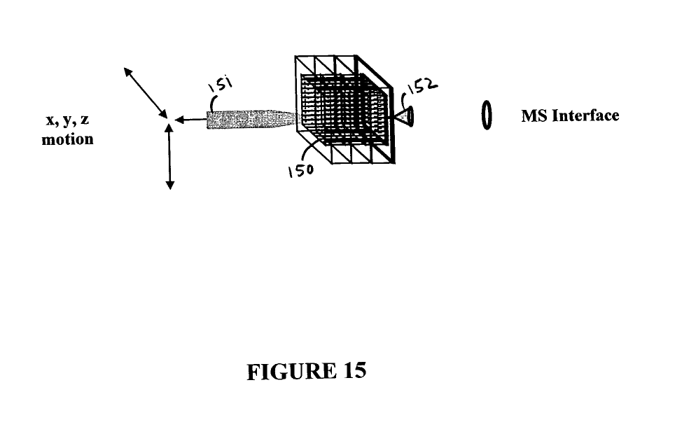

Furthermore, the system allows different separation media to be stacked into one column by stacking more than one tubing array on top of another. A multi-level stack is shown in FIG. 14. The first level tube array 140 is mated to the sample transfer device without leaking, the second level tube array 141 is mated to the first level tube array 140 without leaking, and so on for third 142 and higher level tube arrays (not shown) thus forming a stack 144 of tube arrays. With respect to a single level tube array, a pipette tip 151 forms a seal with the open end of the highest-level tube array 150 in the stack, and provides the electric potential and pneumatic head pressure to initiate electrospray 152 from the nozzle, as shown in FIG. 15.

Thus, the capabilities of forming single-level or multiple-level tube arrays, of using arrays packed with different separation media in each level, and of performing multiple elutions or gradient elutions, yields an automated, flexible, user-configurable micro-scale chromatography array system for separation processes on complex fluid mixtures and solutions.

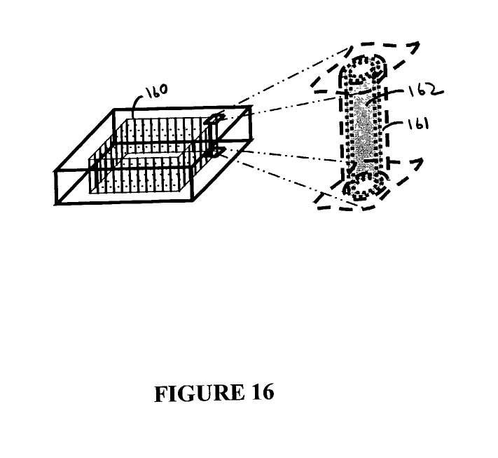

The tubes are held in place by a block, forming a tube array. The first level tube array mounts in alignment to the sample input ports on the back side of a sample transfer device (e.g., the electrospray nozzle chip of a mass spectrometer) so that the tubes may be sealed over the corresponding input ports. The tubes are moveable along their axes (the z-direction) within passageways formed in the block. There is slight lateral play in the fit of the tubes in their passageways. This keeps the tubes aligned to the nozzles even as they are free to move in the z-direction. Referring to FIG. 16, a single-level tube array block 160 is shown having passageways 161 that align the tubes 162 to the nozzles of the sample transfer device and that allow motion of the tubes along their axes.

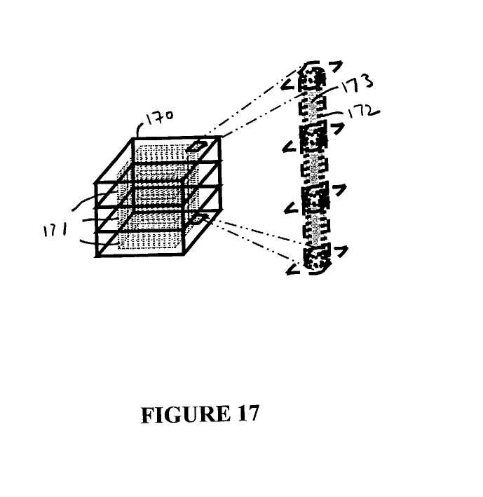

Similarly, when a multi-level, multi-block structure 170 is formed by stacking two or more single-level blocks of tube arrays 171, the tubes in the higher level blocks are held in alignment in the x-y plane within passageways that allow slight lateral play. Referring to FIG. 17, a stack of tube array blocks 171 is shown forming a multi-level tube array 170 with passageways 172 that align the tubes 173 to the nozzles of the sample transfer device and allow perpendicular motion of the tubes.

The tubes may move freely in the z-direction within these passageways. Pressing with a pipette on the open end of a tube in the highest level block transfers compressive force through all of the corresponding tubes in the multi-level stack. This presses the lower end of the first level tube against the sample transfer device to form a seal between the extended column and the sample transfer device. The single extended columns so formed may contain a series of segments of different solid phase separations media.

In a preferred embodiment, the tubes of the arrays are electrically conductive, and preferably composed of an electrically conductive plastic, and thereby allow the fluid inside the tubes to be held at the same electric potential as the tubes themselves. Thus, when used with an electrospray nozzle chip that is electrically insulating, this system provides a novel biasing configuration for electrospray which decouples the electrospray bias from the influence of the mass spectrometer input orifice.

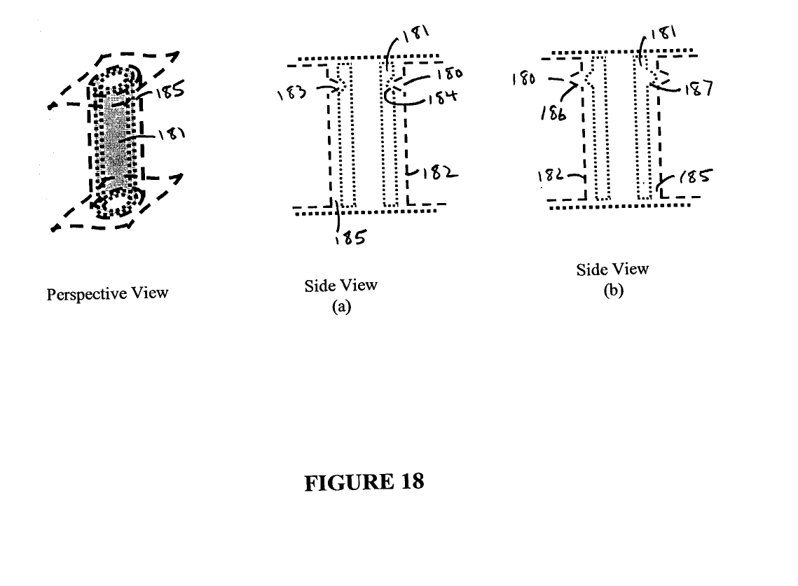

The tolerances for x-y positional accuracy of the tubing and the tubing passageways in the block are optimized to assure both alignment and restricted movement. The tubing is held within the block after it has been inserted and may be subsequently removed if desired. An example of a restraining feature 180 suitable for use to hold the tubes in the present invention is shown in FIG. 18, other methods are also included within the scope of the invention. This feature permits slight motion along the tube axes. Thus, the application of pressure against one end of the tube, transfers that pressure to the other end of the tube, for the purpose of forming seals. Referring to the embodiment shown in FIG. 18, a restraining feature 180 holds the tubes 181 within the passageways 185 of the block 182. One embodiment of the restraining feature 180, shown in FIG. 18(a), holds the tubes 181 within the passageways 185 with an annular groove 184 in the tube 181 which mates with an annular boss 183 within the passageway 185. Another embodiment of the restraining feature 180, shown in FIG. 18(b), holds the tubes 181 within the passageways 185 with an annular groove 186 within the passageway 185 which mates with an annular boss 187 in the tube 181. The fit of the protruding boss 183, 187 into the recessed groove 184, 186 may be either loose or close fitting to allow or restrict the motion of the tube in the z-direction, as may be desired for sealing the junctions between successive tubes 181 and from the tubes 181 to the sample transfer device (not shown).

The free movement of the tubes in their corresponding passageways in the block may be controlled by the addition of a mechanical or pneumatic actuator, including mechanisms involving springs or cantilevers or hydraulic chambers or pistons. These mechanisms allow the tubes to be controllably or automatically moved in or out with respect to the passageways and the sample transfer, electrospray, detector, or other device.

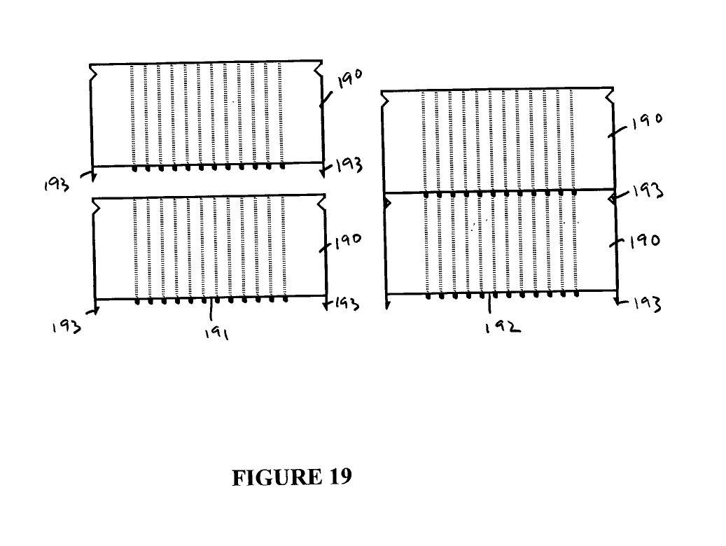

Additionally, there may be a feature to hold adjacent block and tube arrays in mutual contact, e.g., side clips, to hold together a stack of tube array blocks, thereby keeping the tubes in contact with one another even when an individual column of tubes is not being pressed against the sample transfer device during the transfer of the corresponding sample. Referring to FIG. 19, represented is a side view of two tube array blocks 190 before stacking 191 (left) and after stacking 192 (right) employing side clips 193 to hold adjacent blocks and tube arrays in mutual contact.

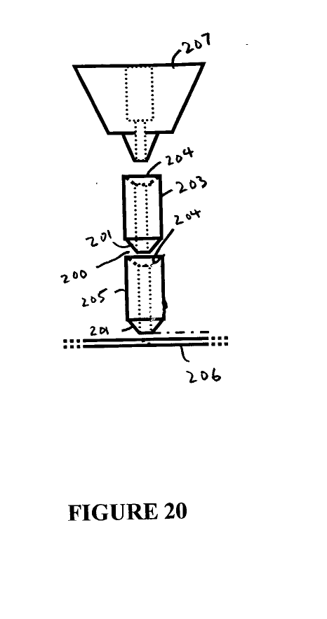

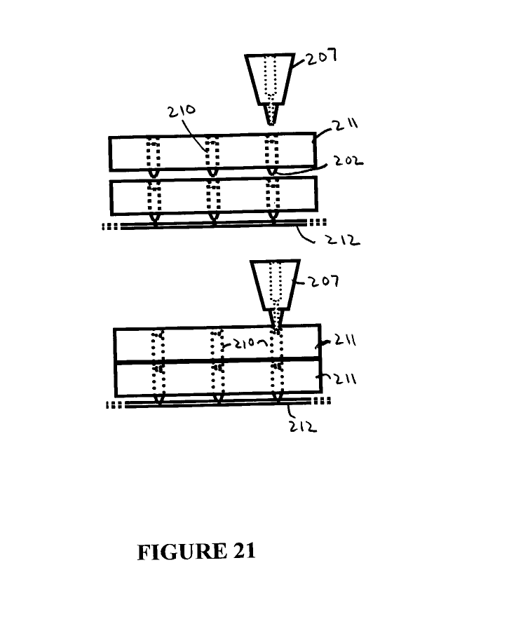

Additionally, there are several features of the design of the tubes and tube array block that facilitate sealing. In one embodiment, the material at the ends of the tube (or the material of the entire tube) is compressible to improve its sealing. The mating interfaces are shaped for optimal alignment and compression for good sealing, see FIGS. 20 and 21.

Referring to FIG. 20, an embodiment of a sealing design 200 is shown having a tapered shape 201 at the tube 203 outlet end 202. The outlet end 202 of one tube 203 fits into the inlet end 204 of another tube 205. Good compressive sealing is ensured by using a narrower taper for the tube outlet end 202 and a wider taper for the tube inlet end 204. The tube outlet end 202 also has a squared-off end surface which can be sealed against the entry port of the back side of a nozzle on the chip 206. FIG. 20 shows two block levels and illustrates how a pipette tip 207 can be used to fill and/or apply head pressure to the inlet end 204 of the tube 203.

Referring to FIG. 21 (not to scale), the tubes 210 using these compression-fitting type tube ends 200 are positioned in the blocks 211 to allow the outlet end 202 of each tube 210 to extend beyond the lower face of the blocks 211. This allows the tube 210 to contact either the back face of the nozzle spray chip 212, or the corresponding tube 210 of the next level tube block 211.

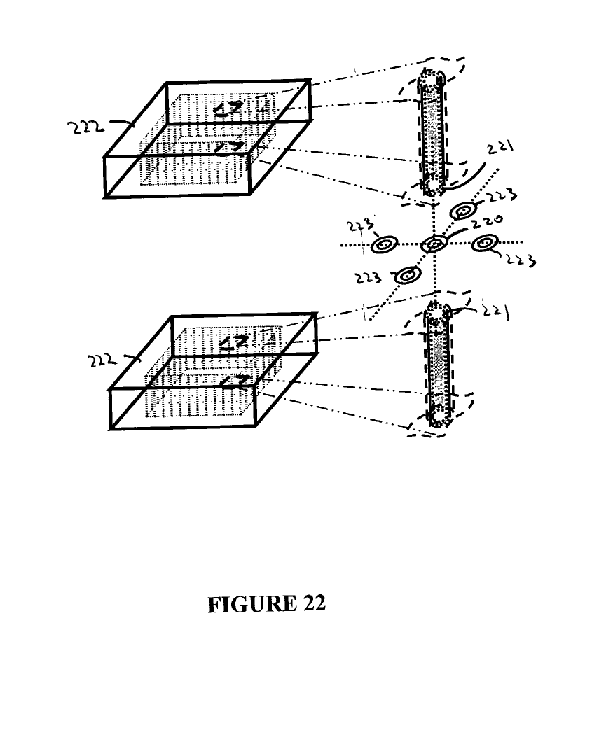

In another embodiment, a compressible gasket or an adhesive sealing material is placed between the tubing and the sample transfer device or at the junctions between successive tubes in a stack of tube arrays. In the latter case, the gasket or sealing material may be electrically conductive. The mating surfaces are shaped for optimal alignment and compression for good sealing, as shown in FIGS. 22-24.

Referring to FIG. 22, one embodiment is shown employing a compressible gasket material 220 between the tube ends 221 of two adjacent blocks 222 in a multi-block stack. A central gasket 220 and four nearest neighbor gaskets 223 are shown. The array of gaskets 220, 223 may be linked as part of a mesh or a sheet.

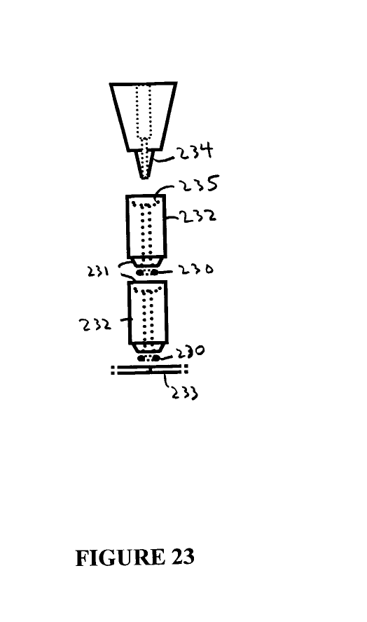

Referring to FIG. 23, one embodiment is shown employing a compressible gasket material 230 between the tube ends 231 of two adjacent blocks 232 in a multi-block stack and between a tube end 231 of the tube in contact with the nozzle spray chip 233. A pipette tip 234 is shown in alignment with the inlet end 235 of the uppermost tube 232. For each level, an array of gaskets 230 may be linked as part of a mesh or a sheet.

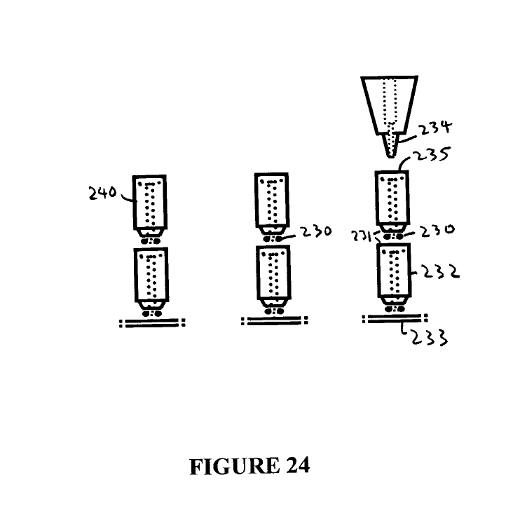

Referring to FIG. 24, one embodiment is shown in which an array 240 of tubes 232 is assembled, aligned with a pipette tip 234, and sealed by gaskets 230, 220, 223, as shown in FIGS. 22 and 23. For each level, the array of gaskets 230, 220, 223 may be linked as part of a mesh or a sheet.

The shapes of the tube ends are optimized for loading by capillary action or for loading by pipetting into either the upper or lower open end, and to minimize any spontaneous leakage of liquid out of the tubing ends after tube loading or after sample transfer to the detector.

The surface energies of the tubing inner surface, the tubing outer surface, and the internal and external surfaces of the block are tailored for optimum liquid control, minimum contamination, and free movement of the tubes in the passageways of the block.

A process according to the present invention for using these blocks and tube arrays with a sample transfer device includes the following:

A. In one embodiment, the first level block (not yet containing tubes) is pre-mounted on the sample transfer device (e.g., the backside of an electrospray nozzle chip) in alignment with the input ports. This assembly is mounted in front of the mass spectrometer input orifice. The tubes corresponding to the first level block are initially held in a separate, “starter” rack prior to loading the liquid samples into the tubes. A robot then loads samples into the tubes by any of several methods.

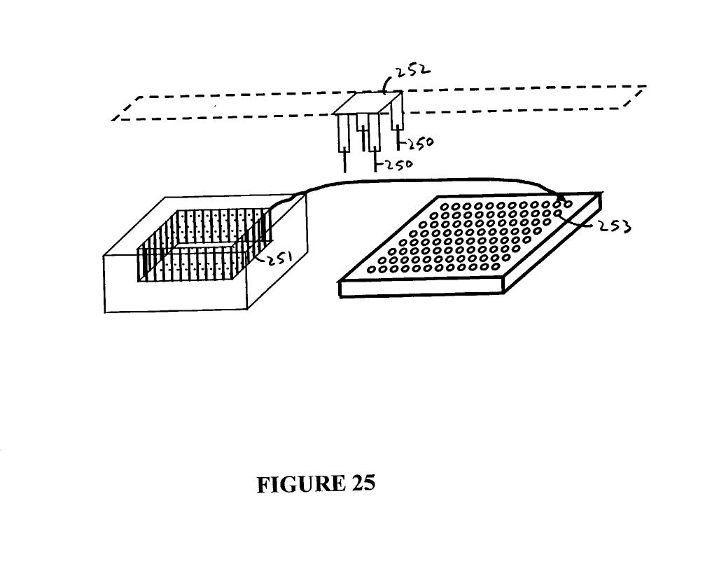

Referring to FIG. 25, one method is shown for loading sample into the tubes 250 from the “starter” rack 251 of tubes. A multi-tube head 252 picks up four tubes 250 from the starter rack 251. Multi-tube head 252 with x, y, z motion places the tubes in communication with a desired well of a 96 well plate 253 containing samples. Each tube 250 is filled from its lower open end by capillary action. The robot may alternately invert the tubes 250 and fill them by capillary action into the upper ends of the tubes 250.

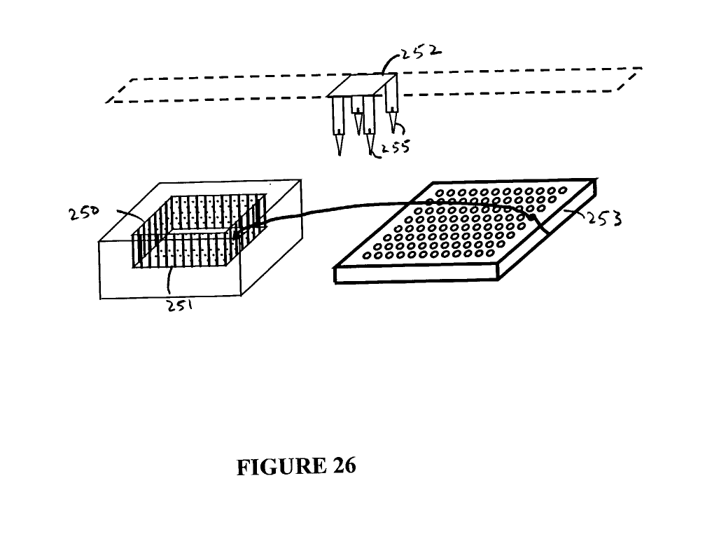

A second method for loading sample into the tubes 250 from the “starter” rack 251 of tubes is shown in FIG. 26. The multi-tube head robot 252 having four tubes or pipette tips 255 dips the tubes 255 into a corresponding well in a rack or multi-well plate 253 containing an array of samples to be tested. The pipetting robot 252 aspirates the sample from a desired well in the array of samples into the tube or pipette tip 255 and dispenses that sample into the upper end of a tube 250 of the starter rack 251. This pipetting robot may have multiple pipetting heads to increase the rate at which the tubes from the “starter” rack are filled with samples, as shown in FIG. 26. Moreover, in all cases the degree of loading of the tubes may either be complete or partial, according to the requirements of the sample quantity or the separation method.

Once a tube is filled with its corresponding sample it can either be taken immediately to the block mounted on the sample transfer device (e.g., the nozzle chip on the mass spectrometer), or it can be kept in the starter rack and moved later by a robot to the block mounted on the sample transfer device.

To assemble multi-level tube arrays, the second level block is next mounted onto the first level block, and so on, until all of the blocks are stacked one on top of the other on the back to form a multi-level tube array block on the sample transfer device.

B. In another embodiment, the first level tubing block is not initially mounted on the sample transfer device (e.g., the nozzle chip). Rather, all of the tube arrays are stacked together first. This stack may be filled with a mobile phase or with a sample, either from the lower open end (the end that mates with the chip) or from the upper open end (the end that mates with the pipette). The degree of filling of multilevel stacked tubes with mobile phase or with sample may either be complete or partial, according to the requirements of sample quantity or the separation method. There is a mechanism to prevent the tube stacks from decoupling and leaking after they have been assembled and filled with fluid.

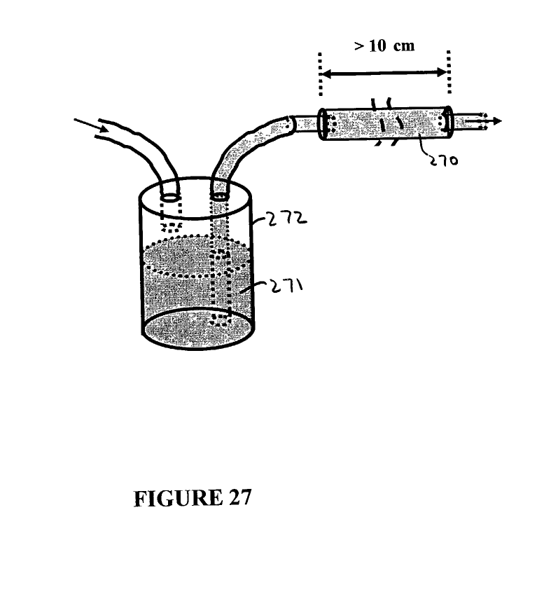

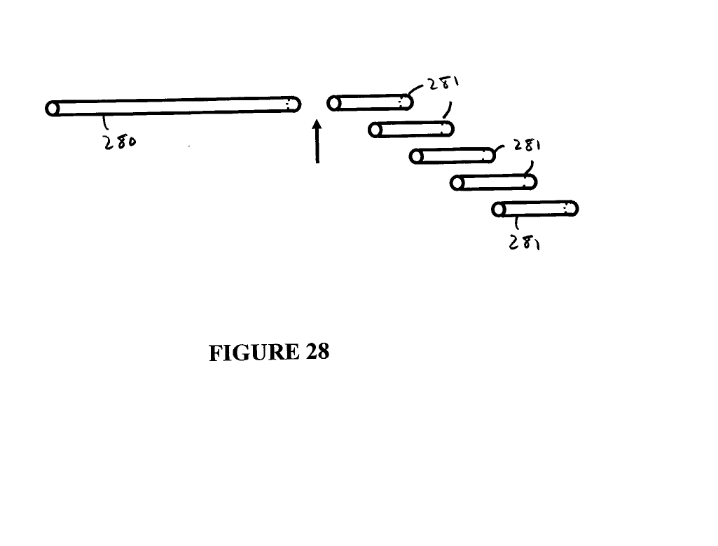

The tubing may be prepared and filled with solid phase media by any of several possible methods. FIG. 27 shows the filling of tubing 270 (not to scale) wherein polymer precursor 271 for stationary phase material flows from a pressurized vessel 272 into and through the tubing 270. Long lengths of tubing are filled with media and then cut up so that each resulting tube segment is filled completely from end to end. FIG. 28 shows cutting pre-filled tubing 280 to provide completely filled tube segments 281. This method may be preferred compared to the separate filling of single tube segments completely from end to end. The shapes and ends of the cut-up tubes 281 may be further modified in accordance with the present invention for holding within the tube passageways and for fluidic sealing.

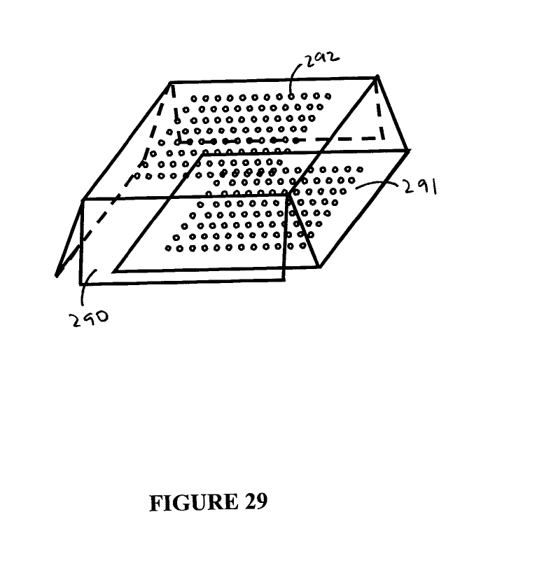

The block of tubes containing samples can be kept cool to prevent degradation of the samples using a wrapping or cover on the block that is heat reflective, thermally insulating, and/or an active cooling element (such as a Peltier device). The block itself can be engineered to have a high heat capacity and/or to contain a phase-changing material that will resist increases in temperature. Referring to FIG. 29, this embodiment shows a cover 290 placed over the block 291 to keep the samples cool. The cover 290 includes an array of holes 292 that allow the tubes to be inserted into the block 291.

This invention enables both increases in the number of tube levels (scaling up the capability of performing separations) and increases in array pitch and density (scaling up the number of samples that can be analyzed in one block). Multi-level columns formed within a stack of blocks where different blocks contain different separation media enable more sophisticated separation processes such as “two-dimensional” liquid chromatography.

In one embodiment of array pitch and density, the tubing array is composed of an 8×12 array of tubes on a pitch of about 2.25 mm. In an embodiment with fourfold higher area density, there is an array of 16×24 tubes on a pitch of about 1.125 mm. Depending on the tube inside diameter and the inside diameter of the corresponding passageway in the block that hold each tube, higher area densities and finer-pitch arrays are enabled by this invention.

Additional design features of the tubes and the tube array block include:

1) The tube ends are optimized to minimize dead volumes at the junctions between successive tubes and between the tubes and the sample transfer device;

2) The tube lengths and volumes are selected to optimize the separation resolution (“theoretical plates”) when used as micro-chromatography columns; and

3) The tubing is electrically conductive, while the block is electrically insulating.

While the invention has been described with preferred embodiments, it is to be understood that variations and modifications may be resorted to as will be apparent to those skilled in the art. Such variations and modifications are to be considered within the purview and the scope of the claims appended hereto.

What is claimed is:

1. A method for sample delivery, comprising:
attaching a first tube to a pipettor;
aspirating a first sample into an outlet end of the first tube;
pressurizing the first tube to deliver the aspirated sample from the outlet end of the first tube to an inlet end of a second tube, wherein the outlet end of the first tube is detachably connected to the inlet end of the second tube; and
washing under pressure the first tube with solvent.

2. The method of claim 1, further comprising delivering elution solvent under pressure to the second tube.

3. The method of claim 2, wherein the second tube is a chromatographic separation column.

4. The method of claim 1, further comprising detaching the first tube from the second tube prior to delivering elution solvent under pressure to the second tube.

5. The method of claim 1, further comprising detaching the first tube from the second tube and discarding the first tube, prior to attaching a third tube to the pipettor.

6. The method of claim 5, further comprising aspirating a second sample into an outlet end of the third tube.

7. The method of claim 6, further comprising pressurizing the third tube to deliver the aspirated sample from the outlet end of the third tube to an inlet end of the second tube, wherein the outlet end of the third tube is detachably connected to the inlet end of the second tube.

8. The method of claim 6, further comprising washing under pressure the third tube with solvent.

9. The method of claim 8, further comprising delivering elution solvent under pressure to the second tube.

10. The method of claim 9, wherein the second tube is a chromatographic separation column.

11. The method of claim 2, further comprising delivering the sample under pressure from an outlet end of the second tube to a detector to detect the sample.

12. The method of claim 3, further comprising delivering the sample under pressure.

13. The method of claim 9, further comprising delivering the sample under pressure from an outlet end of the second tube to a detector to detect the sample.

14. The method of claim 10, further comprising delivering the sample under pressure from an outlet end of the second tube to a detector to detect the sample.

15. The method of claim 11, wherein a gasket sealing layer is disposed between the outlet end of the second tube and an inlet of the detector.

16. The method of claim 12, wherein a gasket sealing layer is disposed between the outlet end of the second tube and an inlet of the detector.

17. The method of claim 13, wherein a gasket sealing layer is disposed between the outlet end of the second tube and an inlet of the detector.

18. The method of claim 14, wherein a gasket sealing layer is disposed between the outlet end of the second tube and an inlet of the detector.

19. The method of claim 1, wherein said first and second tubes are disposable.

20. The method of claim 5, wherein said third tube is disposable.

21. The method of claim 1, further comprising simultaneously processing multiple samples utilizing multiple pipettors and multiple tubes.

22. A method for chemical analysis, comprising:
attaching a first tube to a pipettor;
aspirating a first sample into an outlet end of the first tube;
pressurizing the first tube to deliver the aspirated sample from the outlet end of the first tube to an inlet end of a second tube containing separation media, wherein the outlet end of the first tube is detachably connected to the inlet end of the second tube;
washing under pressure the first tube with solvent; and
delivering under pressure elution solvent to the second tube.

23. The method of claim 22, further comprising detecting the sample exiting the second tube.

24. The method of claim 22, further comprising detaching the first tube from the second tube and discarding the first tube, prior to attaching a third tube to the pipettor.

25. The method of claim 24, further comprising aspirating a second sample into an outlet end of the third tube.

26. The method of claim 25, further comprising pressurizing the third tube to deliver the aspirated sample to the inlet end of the second tube, wherein the outlet end of the third tube is detachably connected to the inlet end of the second tube.

27. The method of claim 26, further comprising washing under pressure the third tube with solvent.

28. The method of claim 27, further comprising delivering under pressure elution solvent to the second tube.

29. The method of claim 28, further comprising delivering the sample under pressure from an outlet end of the second tube to a detector to detect the sample.

30. The method of claim 29, wherein a gasket sealing layer is disposed between the outlet end of the second tube and an inlet of the detector.

31. The method of claim 22, wherein said first and second tubes are disposable.

32. The method of claim 24, wherein said third tube is disposable.

33. The method of claim 22, further comprising simultaneously processing multiple samples utilizing multiple pipettors and multiple tubes.

34. A disposable tube comprising an inlet end and an outlet end, wherein the inlet end of a first tube is self-locking, self-aligning, self-mating, self-sealing and adapted to detachably engage an outlet end of a second tube.

35. The tube of claim 34, further comprising a second tube detachably connected at an inlet end to an outlet end of said tube so as to form a pressure seal.

36. The tube of claim 34, wherein said tube is filled with separation media.

37. The tube of claim 35, further comprising a plurality of tubes detachably connected, each tube filled with a separation media different than that of at least one other tube.

38. The tube of claim 34, wherein said tube is constructed of a flexible tube encapsulated by a material having structural rigidity.

39. The tube of claim 34, having an inlet end detachably connectable to a pipettor.

40. The tube of claim 34, having an inner diameter of from about 5 microns to about 500 microns.

41. The tube of claim 34, wherein the tube is electrically conductive and thereby allows the fluid inside the tube to be held at the same electrical potential as the tube.

42. A method for chromatographic separation in one or more dimensions utilizing one or more disposable columns comprising:
providing a single column or multiple columns detachably connected together, each column having an inlet end and an outlet end and filled with solid phase media;
loading a column or multiple columns at the inlet end with at least one sample analyte;
placing the outlet end of the column or multiple columns in fluid contact with an inlet of a detector;
eluting the at least one analyte from the column or multiple columns to the detector; and
detecting the at least one analyte.

43. The method of claim 42, further comprising ionizing the at least one analyte prior to entering the detector, wherein the detector is a mass spectrometer.

44. The method of claim 42, wherein the outlet end of one column is self-locking, self-aligning, self-mating, self-sealing and adapted to detachably engage an inlet end of another column so as to provide a liquid-tight seal.

45. The method of claim 42, wherein one column of the multiple columns contains different solid phase media than another column.

46. The method of claim 42, wherein said method steps are automated.

47. The method of claim 42, wherein said column or multiple columns comprise a substantially constant inner diameter within the range of from about 5 microns to about 500 microns.

48. The method of claim 43, wherein said ionization is performed by an electrospray device.

49. The method of claim 43, further comprising providing a miniaturized column-switching device disposed between parallel fluid streams and coupled to the outlet end of an upstream column and the inlet end of a downstream column.

50. The method of claim 49, wherein said miniaturized column-switching device comprises a cylinder having a plurality of loops contained within the cylinder.

51. The method of claim 42, wherein a gasket sealing layer is disposed between the outlet end of the column or multiple columns and the inlet of the detector.

52. The method of claim 48, wherein a gasket sealing layer is disposed between the outlet end of the column or multiple columns and an inlet of the electrospray device.

53. The method of claim 42, further comprising simultaneously processing multiple samples utilizing multiple pipettors and multiple columns.

54. A tube array comprising:
a plurality of tube holders adjacent one another;
each tube holder comprising a passageway configured to receive a tube; wherein when filled with a tube, each passageway constrains the movement of the tube such that the tube has free movement along the tube axis but limited sideways movement of the tube, so that the tube is capable of being held in alignment with a corresponding device.

55. The tube array of claim 54, further comprising a second tube array having a plurality of tube holders adjacent one another and stacked on top of an in alignment with a corresponding tube holder of said plurality of tube holders of the first tube array.

56. The tube array of claim 54, wherein at least one of said tubes contains an internal coating or media that facilitates separation.

57. The tube array of claim 56, wherein said internal coating or media facilitates a chromatographic separation.

58. The tube array of claim 54, wherein the tubes of the array are electrically conductive and thereby allow the fluid inside the tubes to be held at the same electrical potential as the tubes.

59. The tube array of claim 55, wherein a gasket sealing layer is disposed between the first and second tube arrays.

60. An automated sample handling system comprising:
an array of tubes at least partially pre-filled with sample and or mobile phase solution;
a sample transfer device; and
an automated fluid control system for loading at least one of the tubes of the array of tubes and actuating the sample transfer device; wherein said samples are dispensed from the tube array into a sample detection device.

61. The system of claim 60, wherein at least one of said sample filled tubes is at least partially filled with a separation media.

62. The system of claim 61, wherein said separation media is a chromatographic separation media.

63. The system of claim 60, further comprising a second array of tubes stacked on top of and in alignment with a corresponding first array of tubes.

64. The system of claim 60, wherein said sample detection device is a mass spectrometer.

65. The system of claim 60, wherein the tubes of the array are electrically conductive and thereby allow the fluid inside the tubes to be held at the same electrical potential as the tubes.

66. The system of claim 65, wherein the tubes of the array are composed of an electrically conductive plastic.

67. A method for minimizing evaporation of sample, comprising:
loading at least one sample in a tube of an array of tubes, which array comprises a plurality of tube holders adjacent one another, each tube holder comprising a passageway configured to receive a tube, wherein each passageway constrains the movement of the tube such that the tube has free movement along the tube axis but limited sideways movement of the tube, so that the inlet of the tube is capable of being held in alignment with a corresponding device.
